(19) United States
(12) Patent Application Publication
(10) Pub. No.: US 2021/0347386 A1
(43) Pub. Date: Nov. 11, 2021

(54) INFORMATION PROCESSING APPARATUS, INFORMATION PROCESSING METHOD, COMPUTER PROGRAM, AND PACKAGE RECEIPT SUPPORT SYSTEM

(71) Applicant: Sony Corporation, Tokyo (JP)

(72) Inventors: Takeshi Katayama, Tokyo (JP); Yasuyuki Kato, Tokyo (JP)

(73) Assignee: Sony Corporation, Tokyo (JP)

(21) Appl. No.: 17/278,561

(22) PCT Filed: Sep. 9, 2019
(86) PCT No.: PCT/JP2019/035417

§ 371 Date: Mar. 22, 2021

(30) Foreign Application Priority Data
Oct. 2, 2018 (JP) 2018-187745

(51) Int. Cl. B60W 60/00; G07C 9/00; G07C 9/33; G06Q 30/00; G06Q 10/08; G01C 21/20; H04N 7/18; G06K 9/00; B62D 57/032

(52) U.S. Cl. CPC B60W 60/00256; G07C 9/00563; G07C 9/33; G06Q 30/0185; B60W 2420/42; G01C 21/206; H04N 7/185; G06K 9/00664; B62D 57/032; G06Q 10/08355

(57) ABSTRACT

There is provided methods and apparatus for a package receipt support system. The package delivery support system includes a lock driving apparatus. The package delivery support system also includes an information processing apparatus comprising a body and a movement device attached thereto, wherein the body comprises a control unit in communication with the movement device. The control unit includes a processor and a memory configured to store instructions that, when executed by the processor, cause the processor to communicate with the lock driving apparatus to unlock an entrance to a building, detect data indicative of a delivery person within the building, and guide the delivery person to a package delivery location. Guiding the delivery person includes controlling the movement device to move the information processing apparatus in a direction that guides the delivery person to the package delivery location, and monitoring the delivery person.

### CROSS REFERENCE TO RELATED APPLICATIONS

This application claims the benefit of Japanese Priority Patent Application JP 2018-187745 filed on Oct. 2, 2018, the entire contents of which are incorporated herein by reference.

### TECHNICAL FIELD

The technology disclosed in this specification relates to an information processing apparatus, an information processing method, a computer program, and a package receipt support system that perform a process for supporting the receipt of a package by a user.

### BACKGROUND ART

As usage of online shopping over the Internet and the like has expanded, logistics services by delivery companies and the postal service have flourished. Also, recently, home delivery boxes for a case where the recipient is not at home are becoming popular. For example, there has been proposed a home delivery box provided with a speech recognizing means that extracts word information from speech uttered by a visitor, a speech selecting means that selects a speech message corresponding to the word information extracted by the speech recognizing means, and a speech outputting means that outputs the speech message selected by the speech selecting means, in which the home delivery box automatically responds to a delivery person and receives a package (see PTL 1).

In the case of using a home delivery box to receive a package, the recipient must retrieve the package from the home delivery box and carry the package indoors. The carry-in work is burdensome, and the burden of the work increases in cases where the package is large or heavy. For example, in the case in which the home delivery box is installed in the entrance of a housing complex, the work burden increases further. Also, in the case in which a home delivery box is not used and the package is placed in the doorway, the work of carrying the package indoors is still similarly necessary.

Also, there has been proposed a home delivery system enabling the delivery driver to deliver a package indoors even when the recipient is not at home by combining an advanced door-unlocking apparatus capable of confirming the delivery time and the authenticity of the delivery driver and a fixed camera capable of streaming, over a network, an image enabling a person to monitor the state of the delivery driver placing the package indoors. The recipient who is not at home is able to observe the delivery driver through the image streamed from the fixed camera on an information terminal such as a smartphone carried by the recipient oneself, for example. However, since the delivery driver is only able to move around within the field of view of the fixed camera, the recipient must carry the package oneself from the place where the delivery driver has placed the package to a desired place. Although it is possible to increase the number of fixed cameras such that the delivery driver can be observed over a wider range, costs increase, and furthermore camera blind spots cannot be eliminated completely.

### CITATION LIST

### Patent Literature

### PTL 1: JP 2013-126498A

### PTL 2: JP 2016-223277A

### SUMMARY

### Technical Problem

It is desirable to provide an information processing apparatus, an information processing method, a computer program, and a package receipt support system that make it possible for a package to be carried into a room safely while a user is not at home or the like.

### Solution to Problem

According to the present disclosure, there is provided an information processing apparatus. The information processing apparatus comprises a body and a movement device attached thereto, wherein the body comprises a control unit in communication with the movement device. The control unit comprises a processor and a memory configured to store instructions that, when executed by the processor, cause the processor to detect data indicative of a delivery person within a building, and guide the delivery person to a package delivery location. Guiding the delivery person comprises controlling the movement device to move the information processing apparatus in a direction that guides the delivery person to the package delivery location, and monitoring the delivery person.

According to the present disclosure, there is provided a method. The method comprises using a control unit of an information processing apparatus comprising a processor and a memory configured to store instructions that, when executed by the processor, cause the processor to perform the acts of detecting data indicative of a delivery person within a building, and guiding the delivery person to a package delivery location.

Guiding the delivery person comprises controlling a movement device attached to a body comprising the processor to move the information processing apparatus in a direction that guides the delivery person to the package delivery location, and monitoring the delivery person.

According to the present disclosure, there is also provided

According to the present disclosure, a package receipt support system is provided. The package receipt support system comprises a lock driving apparatus. The package receipt support system comprises an information processing apparatus comprising a body and a movement device attached thereto, wherein the body comprises a control unit in communication with the movement device. The control unit comprises a processor and a memory configured to store instructions that, when executed by the processor, cause the processor to communicate with the lock driving apparatus to unlock an entrance to a building, detect data indicative of a delivery person within the building, and guide the delivery person to a package delivery location.

Guiding the delivery person comprises controlling the movement device to move the information processing apparatus in a direction that guides the delivery person to the package delivery location, and monitoring the delivery person.

### Advantageous Effects of Invention

According to the technology disclosed in this specification, an information processing apparatus, an information processing method, a computer program, and a package receipt support system that make it possible for a package to be carried into a room safely while a user is not at home or the like can be provided.

Note that the advantageous effects described in this specification are merely for the sake of example, and the advantageous effects of the present disclosure are not limited thereto. Furthermore, in some cases the present disclosure may also exhibit additional advantageous effects other than the advantageous effects given above.

Further objectives, features, and advantages of the technology disclosed in this specification will be clarified by a more detailed description based on the exemplary embodiments described hereinafter and the attached drawings.

### BRIEF DESCRIPTION OF DRAWINGS

FIG. 1 is a diagram schematically illustrating an exemplary configuration of a package receipt support system 100.

FIG. 2 is a diagram illustrating an exemplary functional configuration of a lock driving apparatus 101.

FIG. 3 is a diagram illustrating an exemplary configuration of the external appearance of a pet-type robot 300.

FIG. 4 is a diagram illustrating an exemplary internal configuration of the robot 300.

FIG. 5 is a diagram illustrating an exemplary functional configuration of a main control unit of the robot 300.

FIG. 6 is a diagram illustrating an exemplary internal configuration of an information terminal 103.

FIG. 7 is a diagram illustrating an exemplary operation sequence performed by the package receipt support system 100.

FIG. 8 is a diagram illustrating how a user issues an unlock instruction to a robot.

FIG. 9 is a diagram illustrating how the robot responds to a call from a delivery person.

FIG. 10 is a diagram illustrating how the robot responds to the call from the delivery person.

FIG. 11 is a diagram illustrating how the robot unlocks a front door.

FIG. 12 is a diagram illustrating how the robot confirms a package ID.

FIG. 13 is a diagram illustrating how the robot leads the delivery person to a package storage location.

FIG. 14 is a diagram illustrating how the robot instructs the delivery person to store the package in the package storage location.

FIG. 15 is a diagram illustrating how the robot leads the delivery person to a dwelling entrance.

FIG. 16 is a diagram illustrating how the robot transmits an acknowledgment of receipt.

FIG. 17 is a diagram illustrating how the robot stands by at a charger.

FIG. 18 is a diagram illustrating how the robot issues a warning or a report about a suspicious delivery person.

FIG. 19 is a flowchart illustrating a processing sequence executed for the robot to receive the package instead of the user.

### DESCRIPTION OF EMBODIMENTS

Hereinafter, an embodiment of the technology disclosed in the present specification will be described in detail with reference to the drawings.

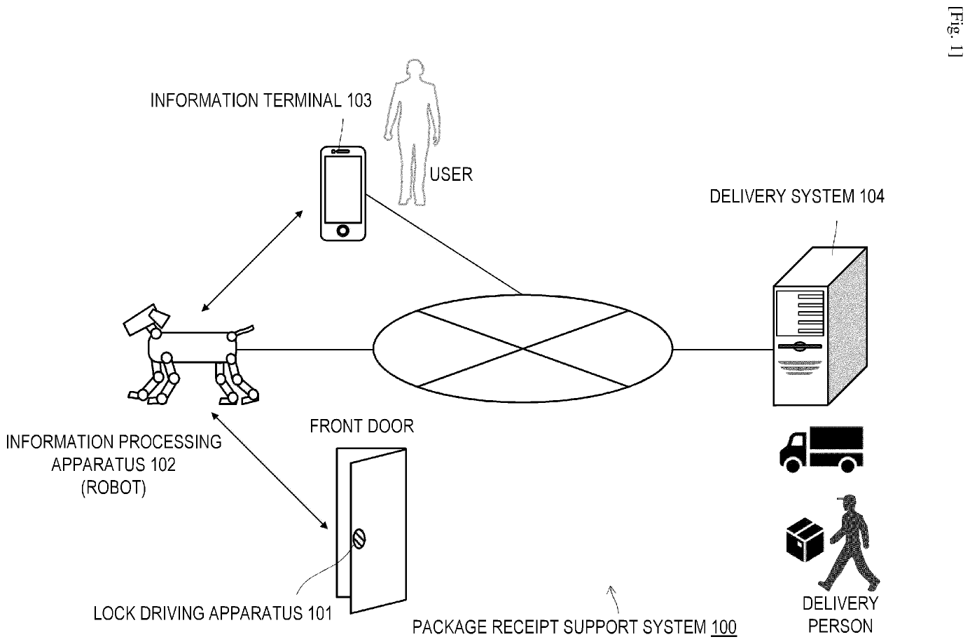

FIG. 1 schematically illustrates an exemplary configuration of a package receipt support system 100 applying the technology disclosed in this specification. Basically, the package receipt support system 100 illustrated in the drawing is applied inside a room of a user who is the recipient of a package, and provides a service that supports the receipt of the package from a delivery person when the user is not at home. Obviously, the package receipt support system 100 is taken to be similarly capable of supporting the receipt of a package not only in a case where the user is not at home, but also in cases where the user is at home but is too busy to deal with the delivery person, and in cases where the user is unable to deal with the delivery person for some reason, such as when the user is in a bad mood.

The package receipt support system 100 is provided with a lock driving apparatus 101 that locks and unlocks the front door of the room (or house) where the system 100 is installed, an information processing apparatus 102 that fulfills the primary role for realizing the package receipt support service, and an information terminal 103 carried by the user. The package receipt support system 100 can cooperate as appropriate with a delivery system 104 of a delivery company that delivers the package to the user's room to provide the package receipt support service to the user.

The lock driving apparatus 101 is a device capable of operations of remotely locking and unlocking the front door by short-range wireless communication, such as a smart lock for example. For example, the lock driving apparatus disclosed in Patent Literature 2 can be applied.

The information processing apparatus 102 includes a communication unit capable of communicating with the lock driving apparatus 101 by short-range wireless communication, and a main control unit according to the state such as the package delivery status and the status inside the room. However, in FIG. 1, the communication unit and the main control unit are omitted from illustration.

The short-range wireless communication that the communication unit performs with the lock driving apparatus 101 may be Bluetooth (registered trademark) communication or Wi-Fi (registered trademark) for example, but is not limited to these communication standards. In addition, the communication unit may also be connected to the lock driving apparatus 101 by wired communication rather than short-range wireless communication, but considering that the information processing apparatus 102 is a mobile object as described later, wireless communication is preferable.

The main control unit controls the driving of the lock driving apparatus 101 through the communication unit, locking and unlocking the front door depending on the status. The “status” referred to herein includes the delivery status of the package ordered by the user, the status of the delivery person delivering the package, and the like, but details will be described later.

Also, the information processing apparatus 102 is configured as a mobile object and is capable of autonomously searching the inside the user's room. The “mobile object” referred to herein is specifically a pet-type robot, but is not necessarily limited thereto. For example, the “mobile object” may also be a humanoid robot, an unmanned aerial vehicle such as a drone, a robot vacuum cleaner, or the like. The main control unit controls the movement of the information processing apparatus 102 as a mobile object according to the delivery status of the package ordered by the user, the status of the delivery person delivering the package, and the like. For example, technologies such as simultaneous localization and mapping (SLAM) and time of flight (ToF) may be used to search for a movement route while also estimating one's own position. Alternatively, rather than being a mobile object, the information processing apparatus 102 may be a stationary device such as a speech agent. However, if the information processing apparatus 102 is a mobile object, the information processing apparatus 102 can guide the delivery person into the user's room for carrying in the package, track the delivery person inside the user's room, and track and monitor the delivery person until the delivery person exits the room.

The information terminal 103 is configured as a smartphone, a tablet, a personal computer, or the like, for example. Through a screen of the information terminal 103 (or by using speech input), the user is able to order a package and designate a delivery time with respect to the delivery system 104 of the delivery company.

Note that it is anticipated that the user will order a package and designate a delivery time with respect to an e-commerce business, and the e-commerce business will additionally designate the delivery and the delivery time of the package ordered by the user with respect to the delivery company. However, for the sake of simplicity, this specification assumes that ordering the package and designating the delivery time are performed in a unified manner with respect to the delivery company.

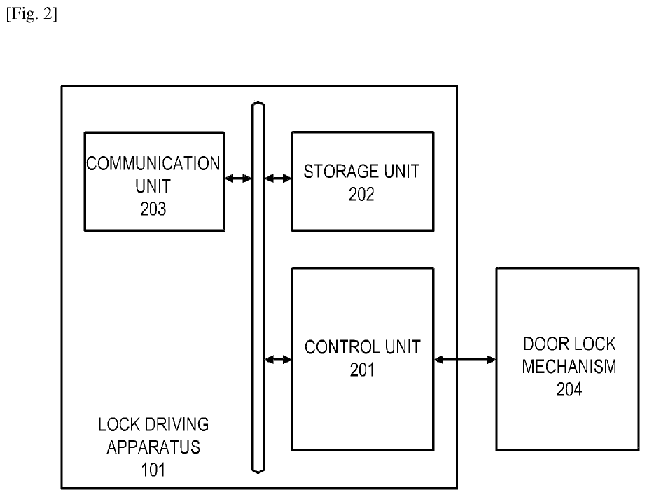

FIG. 2 illustrates an exemplary functional configuration of the lock driving apparatus 101. The illustrated lock driving apparatus 101 is provided with a control unit 201, a storage unit 202, and a communication unit 203.

The communication unit 203 is provided with a communication interface that communicates with the information processing apparatus 102 by short-range wireless communication such as Bluetooth (registered trademark) communication or Wi-Fi (registered trademark) for example. Note that the communication unit 203 is also func-tionally capable of wireless communication with the information terminal 103 such as a smartphone, and furthermore may also be connected to the Internet, but since the above does not relate directly to the technology disclosed in this specification, a detailed description is omitted.

The control unit 201 includes a processor and memory (neither of which is illustrated), and achieves various processes by having the processor execute a program loaded into the memory. For example, the control unit 201 controls communication by the communication unit 203, performs a process of authenticating the information processing apparatus 102, the information terminal 103, or the like connected through the communication unit 203, and controls the locking and unlocking of a door lock mechanism 204 based on an instruction from the authenticated information processing apparatus 102 or information terminal 103. Also, in the case of using communicating that requires pairing, such as Bluetooth (registered trademark) communication, the control unit 201 also performs the pairing process with the information processing apparatus 102 and the information terminal 103.

The storage unit 202 stores various programs executed by the control unit 201 and stores various information used in the control unit 201, such as authentication information.

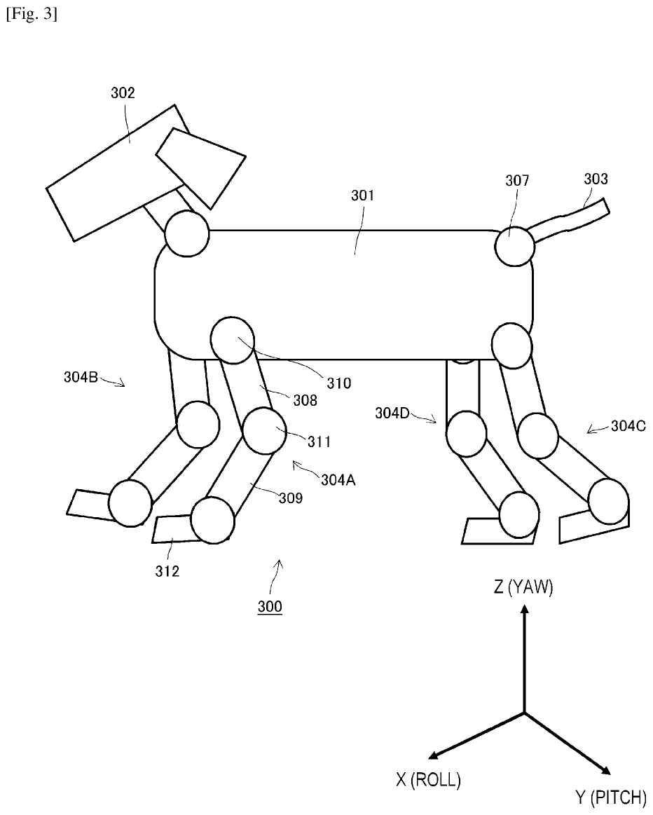

FIG. 3 illustrates an exemplary external appearance of the pet-type robot 300 applied as the information processing apparatus 102 in the package receipt support system 100 according to the present embodiment. The robot 300 basically operates as an au-tonomous mobile apparatus, but may also be equipped with a speech recognition function and a conversation function and be configured to operate as a speech agent.

The illustrated robot 300 includes a torso unit 301, a head unit 302, a tail 303, and four limbs, namely leg units 304A, 304B, 304C, and 304D.

The head unit 302 is disposed near the front-upper end of the torso unit 301 through a neck joint 7 having the degree of freedom of each of the roll, pitch, and yaw axis directions.

Also, in the head unit 302, a camera (stereo camera) corresponding to the “eyes” of a dog, a microphone corresponding to the “ears”, a speaker corresponding to the “mouth”, a touch sensor corresponding to tactile sensation, and the like are installed. Besides the above, sensors that form the five senses of a living body may also be included.

The tail 303 is disposed near the rear-upper end of the torso unit 301 through a tail joint 307 having the degrees of freedom of the roll and pitch axes. The tail 303 may also be curved or swingable.

The leg units 304A and 304B form the left and right forelegs, while the leg units 304C and 304D form the left and right hind legs. Each of the leg units 304A, 304B, 304C, and 304D is formed as the combination of a femoral unit 308, a tibial unit 309, and a foot unit 312, and is attached to the four corners on the left and right in the front and rear on the bottom face of the torso unit 301. The femoral unit 308 is joined to each of the predetermined sites of the torso unit 301 by a hip joint 310 having the degree of freedom of each of the roll, pitch, and yaw axes. Also, the femoral unit 308 and the tibial unit 309 are joined by a knee joint 311 having the degrees of freedom of the roll and pitch axes. Also, the tibial unit 309 and the foot unit 312 are joined by an ankle joint having the degrees of freedom of the roll and pitch axes.

The joint degrees of freedom of the robot 300 are actually provided by the driving of actuators (not illustrated) such as motors disposed on every axis. However, the robot 300 may have any number of joint degrees of freedom, and is not limited to the degree-of-freedom configuration described above. Although omitted from the above description, the robot 300 additionally may be provided with joint degrees of freedom for wagging the left and right ears.

Also, the speaker for speech output is disposed near the “mouth” of the head unit 302, the stereo camera is disposed near the left and right “eyes”, and the microphone for speech input is disposed near at least one of the left or right “ear”.

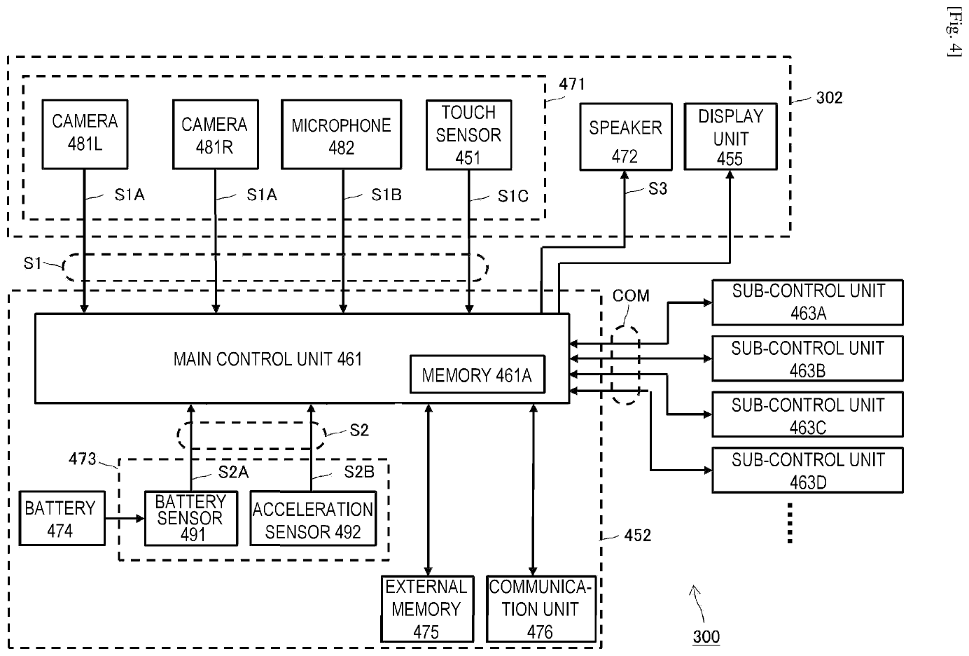

FIG. 4 illustrates an exemplary internal configuration of the robot 300 applied as the information processing apparatus 102.

In the head unit 302, cameras 481L and 481R that function as the left and right “eyes” of the robot 300, a microphone 482 that functions as the “ears”, a touch sensor 451, and the like are arranged at respectively predetermined positions as an external sensor unit 471. For the cameras 481L and 481R, cameras including an image sensor such as a complementary metal-oxide semiconductor (CMOS) sensor or a charge-coupled device (CCD) sensor for example are used.

Note that, although omitted from illustration, the external sensor unit 471 additionally may include other sensors. For example, the external sensor unit 471 may also be provided with a sensor capable of measuring or estimating the direction of and distance to a predetermined target, such as laser imaging detection and ranging (LIDAR), a time-of-flight (TOF) sensor, or a laser range sensor. In addition, the external sensor unit 471 may also include a Global Positioning System (GPS) sensor, an infrared sensor, a temperature sensor, a humidity sensor, an illuminance sensor, and the like.

Also, in the head unit 302, a speaker 472, a display unit 455, and the like that act as output units are arranged at respectively predetermined positions. The speaker 472 outputs speech and functions as the “mouth”. Also, the state of the robot 300 and responses to the user are displayed on the display unit 455.

Inside a control unit 452, a main control unit 461, a battery 474, an internal sensor unit 473 including a battery sensor 491, an acceleration sensor 492, and the like, external memory 475, and a communication unit 476 are arranged. The control unit 452 is installed inside the torso unit 301 of the robot 300 for example.

The cameras 481L and 481R of the external sensor unit 471 image the surrounding situation and transmit obtained image signals S1A to the main control unit 461. The microphone 482 collects speech input from the user and transmits an obtained speech signal S1B to the main control unit 461. Note that although only a single microphone 482 is illustrated in FIG. 4, two or more microphones may also be provided in corre-spondence with the left and right ears.

Also, the touch sensor 451 of the external sensor unit 471 is disposed in an upper part of the head unit 302 for example, detects pressure received by a physical influence such as “petting” or “spanking” from the user, and transmits the detection result to the main control unit 461 as a pressure detection signal S1C.

The battery sensor 491 of the internal sensor unit 473 detects the amount of remaining energy in the battery 474 on a predetermined interval, and transmits the detection result to the main control unit 461 as a battery level detection signal S2A.

The acceleration sensor 492 detects the acceleration of the movement of the robot 300 in three axis directions (x-axis, y-axis, and z-axis) on a predetermined interval, and transmits the detection result to the main control unit 461 as an acceleration detection signal S2B. For example, the acceleration sensor 492 may be an inertial measurement unit (IMU) equipped with a 3-axis gyro, a tri-directional acceleration sensor, and the like.

The external memory 475 stores programs, data, control parameters, and the like, and supplies the programs and data to memory 461A built into the main control unit 461 as appropriate. Also, the external memory 475 receives and stores data and the like from the memory 461A. Note that the external memory 475 may be configured as a cartridge-type memory card, like an SD card for example, and may be removable from the body of the robot 300 (or the control unit 452).

The communication unit 476 performs data communication with external equipment on the basis of a communication method such as Wi-Fi (registered trademark) or Long Term Evolution (LTE) for example. For example, programs such as applications to be executed by the main control unit 461 and data required to execute such programs can be acquired from external equipment through the communication unit 476. Also, the present embodiment anticipates that the communication unit 476 communicates with the lock driving apparatus 101 by short-range wireless communication and also communicates with the information terminal 103 carried by the user and with the delivery system 104. Also, the communication unit 476 may be equipped with the reader function in the near field communication (NFC) standard.

The main control unit 461 includes a processor such as a central processing unit (CPU), as well as the built-in memory 461A. The memory 461A stores programs and data, and the main control unit 461 performs various processes by executing the programs stored in the memory 461A. In other words, the main control unit 461 determines the status around and inside the robot 300 on the basis of the image signals S1A, the speech signal S1B, and the pressure detection signal S1C respectively supplied from the cameras 481L and 481R, the microphone 482, and the touch sensor 451 of the external sensor unit 471 (hereinafter, these signals will be collectively referred to as the external sensor signal S1), and the battery level detection signal S2A and the acceleration detection signal S2B respectively supplied from the battery sensor 491, the acceleration sensor 492, and the like of the internal sensor unit 473 (hereinafter, these signals will be collectively referred to as the internal sensor signal S2). For example, the main control unit 461 determines the status of the package delivery person that the robot 300 has invited into the user's room. Also, the main control unit 461 performs image recognition on the image signals S1A as well as speech recognition on the speech signal S1B, and performs a handling process.

Additionally, on the basis of the status around and inside the robot 300, an instruction from the user or a determination result of the presence or absence of an influence from the user, the control program stored in advance in the memory 461A, various control parameters stored in the external memory 475 loaded at that time, or the like, the main control unit 461 decides an action of the robot 300 and an expressive behavior to exhibit toward the user, generates control commands based on the decision result, and transmits the generated control commands to each sub-control unit 463A, 463B, and so on. The sub-control units 463A, 463B, and so on control the driving of the actuators (not illustrated) that cause each unit such as the torso unit 301, the head unit 302, and the leg units 304A, 304B, 304C, and 304D to operate on the basis of the control commands supplied from the main control unit 461. With this arrangement, for example, the robot 300 performs actions such as causing the head unit 302 to swing up, down, left, and right, raising up the foreleg units 304A and 304B, or walking by al-ternately driving the foreleg and hind leg units 304A, 304B, 304C, and 304D.

Also, by supplying a predetermined speech signal S3 to the speaker 472 as appropriate, the main control unit 461 causes speech based on the speech signal S3 to be output externally, while in addition, when speech is detected for example, the main control unit 461 displays a response to the user such as “Whooo's that?” on the display unit 455 on the basis of a display signal S4. Furthermore, the main control unit 461 may output driving signals to LEDs not illustrated, which function as the “eyes” to external appearances and which are provided at predetermined positions on the head unit 302, and by causing the LEDs to blink, the LEDs may be made to function as the display unit 455.

In the present embodiment, the main control unit 461 primarily drives the robot 300 according to the delivery status of the package ordered by the user, the status of the delivery person delivering the package, and the like, and performs a process for receiving the package from the delivery person when the user is not at home (or without involving the user). Also, when receiving the package, the robot 300 guides the delivery person into the user's room and tracks the delivery person inside the user's room, but the main control unit 461 may also utilize technologies such as SLAM and ToF to perform a process of searching for a movement route while also estimating one's own position.

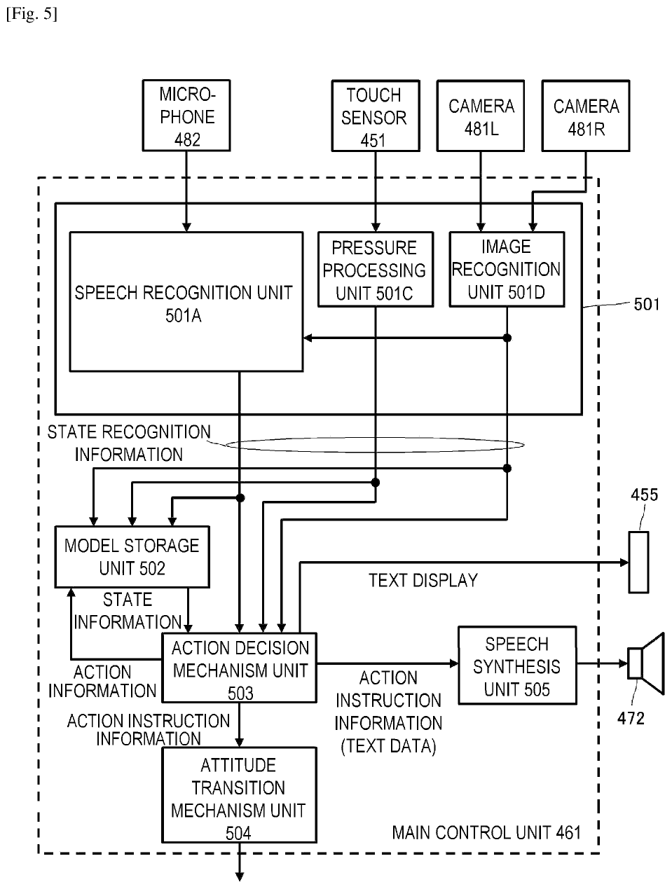

FIG. 5 illustrates an exemplary functional configuration of the main control unit 461 in FIG. 4 (the robot 300). Note that the functional configuration illustrated in FIG. 5 is realized by having the main control unit 461 execute a control program stored in the memory 461A.

The main control unit 461 is provided with a state recognition information processing unit 501, a model storage unit 502, an action decision mechanism unit 503, an attitude transition mechanism unit 504, and a speech synthesis unit 505. The state recognition information processing unit 501 recognizes the external state (such as the behavior and state of the user or the package delivery person, for example). The model storage unit 502 stores a model of the emotions, instincts, state of development, or the like of the robot 300, which is updated on the basis of recognition results from the state recognition information processing unit 501 and the like. The action decision mechanism unit 503 decides an action of the robot 300 on the basis of recognition results from the state recognition information processing unit 501 and the like. On the basis of a decision result from the action decision mechanism unit 503, the attitude transition mechanism unit 504 actually causes the robot 300 to exhibit an action such as an expressive behavior with respect to the outside world (such as the user or the package delivery person, for example). The speech synthesis unit 505 generates synthesized sounds to be output as speech from the speaker 472. Note that the main control unit 461 additionally may be provided with functional configurations other than those indicated by the reference numbers 501 to 505. Hereinafter, each unit will be described in detail.

Speech signals, image signals, and pressure detection signals from the microphone 482, the cameras 481L and 481R, and the touch sensor 451, respectively, are continually input into the state recognition information processing unit 501 while the robot 300 is powered on. Additionally, on the basis of the speech signals, image signals, and pressure detection signals supplied by the microphone 482, the cameras 481L and 481R, and the touch sensor 451, the state recognition information processing unit 501 recognizes a specific external state (such as the behavior or state of the user or the package delivery person, for example), and continually outputs state recognition information expressing the recognition result to the model storage unit 502 and the action decision mechanism unit 503.

The state recognition information processing unit 501 includes a speech recognition unit 501A, a pressure processing unit 501C, and an image recognition unit 501D.

The speech recognition unit 501A detects the presence or absence of speech in the speech signal S1B supplied by the microphone 482, performs signal processing such as speech recognition and speaker identification, and outputs a processing result as state recognition information to the model storage unit 502 and the action decision mechanism unit 503.

The pressure processing unit 501C processes the pressure detection signal S1C supplied by the touch sensor 451, and for example, when a pressure equal to or greater than a predetermined threshold and also of a short duration is detected, the pressure processing unit 501C recognizes “being spanked (scolded)”, whereas when a pressure less than the predetermined value and also of a long duration is detected, the pressure processing unit 501C recognizes “being petted (praised)”. Subsequently, the pressure processing unit 501C notifies the model storage unit 502 and the action decision mechanism unit 503 of the recognition result as state recognition information.

The image recognition unit 501D performs an image recognition process using the image signals S1A supplied by the cameras 481L and 481R, and notifies the speech recognition unit 501A, the model storage unit 502, and the action decision mechanism unit 503 of the image recognition result as state recognition information. Additionally, the image recognition unit 501D may also be provided with a face recognition function and identify the user and the package delivery person.

The model storage unit 502 respectively stores and manages models such as an emotion model, an instinct model, and a development model representing the emotions, instincts, and state of development of the robot 300. Herein, the emotion model includes the state (degree) of emotions such as “happiness”, “sadness”, “anger”, and “enjoyment”, for example. Also, the instinct model includes the state (degree) of instinctual urges such as “appetite”, “need for sleep”, and “need to exercise”, for example. Also, the development model includes the state (degree) of development such as “childhood”, “adolescence”, “adulthood”, and “old age”, for example. In the model storage unit 502, each state of emotion, instinct, and development is respectively expressed by a value in a predetermined range (such as from −1.0 to 1.0, for example). The model storage unit 502 stores a value expressing the state of each emotion and the like, and outputs the values to the state recognition information processing unit 501 as state information, and additionally changes the values on the basis of state recognition information from the state recognition information processing unit 501, the passage of time, and the like.

The action decision mechanism unit 503 manages a finite automaton, in which actions that the robot 300 may take are associated with states, as a behavioral model stipulating the actions of the robot 300. Subsequently, the action decision mechanism unit 503 causes the state in the finite automaton acting as the behavioral model to transition on the basis of the state recognition information from the state recognition information processing unit 501, the values of the emotion model, the instinct model, or the development model in the model storage unit 502, the passage of time, and the like, decides an action corresponding to the transitioned state as the action that the robot 300 should take next, and transmits the content of the action as action instruction information to the attitude transition mechanism unit 504.

At this point, the action decision mechanism unit 503 causes the state to transition upon determining that a predetermined trigger has occurred. In other words, the action decision mechanism unit 503 causes the state to transition when, for example, the amount of time that the robot 300 has been executing the action corresponding to the current state reaches a predetermined time, when specific state recognition information is received, or when the value of an emotion, instinct, or state of development indicated by the state information supplied by the model storage unit 502 becomes a predetermined threshold value or greater, a predetermined threshold value or less, or the like. Also, the action decision mechanism unit 503 also causes the state in the behavioral model to transition on the basis of the values and the like of the emotion model, the instinct model, and the development model in the model storage unit 502. Because of this, even if the same state recognition information is input into the action decision mechanism unit 503, the state to transition to that is decided by the action decision mechanism unit 503 will be different depending on the values (state information) of the emotion model, the instinct model, and the development model.

Also, besides action instruction information that causes the head, four limbs, and the like of the robot 300 to operate, the action decision mechanism unit 503 also generates action instruction information that causes the robot 300 to speak. The action instruction information that causes the robot 300 to speak is supplied to the speech synthesis unit 505. The action instruction information supplied to the speech synthesis unit 505 includes text data or the like corresponding to synthesized sounds to be generated by the speech synthesis unit 505.

Additionally, if the speech synthesis unit 505 receives action instruction information from the action decision mechanism unit 503, the speech synthesis unit 505 generates synthesized sounds on the basis of the text data included in the action instruction information, and supplies the generated synthesized sounds to the speaker 472 for output. Also, the action decision mechanism unit 503 can cause words corresponding to the speech, or in cases where the robot 300 does not speak, words that act as a substitute for speech, to be displayed in text as a prompt on the display unit 455, or emitted by the speaker 472.

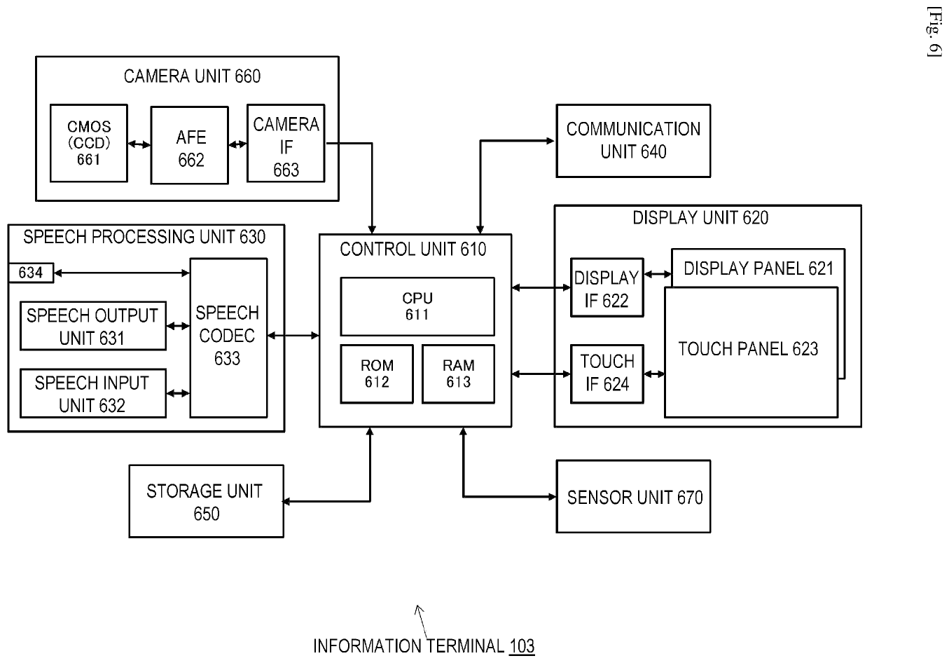

FIG. 6 illustrates an exemplary internal configuration of the information terminal 103. The illustrated information terminal 103 corresponds to a device such as a smartphone or tablet carried by the user, and includes a control unit 610, to which a display unit 620, a speech processing unit 630, a communication unit 640, a storage unit 650, a camera unit 660, a sensor unit 670, and the like are connected.

The control unit 610 includes a CPU 611, read-only memory (ROM) 612, random access memory (RAM) 613, and the like. Program code to be executed by the CPU 611, information relevant to the information terminal 103, and the like are stored in the ROM 612.

The CPU 611 loads program code from the ROM 612 or the communication unit 640 into the RAM 613, and executes the program code. Programs executed by the CPU 611 can include an operating system (OS) such as Android or iOS, and various application programs that run in an execution environment provided by the OS.

For example, an application program for ordering a package from a predetermined online shopping site, an application program for requesting proxy receipt of the package by the information processing apparatus 102 configured as the robot 300, and the like are executed.

The display unit 620 is provided with a display panel 621 containing liquid crystal elements, organic electroluminescence (EL) elements, or the like, and a transparent touch panel 623 applied to the upper face of the display panel 621. The display panel 621 is connected to the control unit 610 through a display interface 622, and displays image information generated by the control unit 610. Also, the transparent touch panel 623 is connected to the control unit 610 through a touch interface 624, and outputs coordinate information indicating where the user operated the display panel 621 with a fingertip to the control unit 610. On the control unit 610 side, touch operations by the user (such as taps, long presses, flicks, and swipes) are detected on the basis of the input coordinate information, and processes corresponding to the user operations are launched.

The speech processing unit 630 is provided with a speech output unit 631 such as a speaker, a speech input unit 632 such as a microphone, and a speech codec 633 that performs coding and decoding processes on input and output speech signals. Also, the speech processing unit 630 additionally may be provided with an output terminal 634 for outputting a speech signal to headphones (not illustrated).

The communication unit 640 executes a process of communicating information between an application executed by the control unit 610 and an external apparatus. The external apparatus referred to herein may be the robot 300 (or the information processing apparatus 102), the lock driving apparatus 101, an information terminal (not illustrated) handled by another user, a server on the Internet, or the like. The speech processing unit 630 is equipped with a physical-layer module such as Wi-Fi (registered trademark), NFC, or Bluetooth (registered trademark) communication according to the communication medium to be used, and performs modulation/demodulation processes and coding/decoding processes on communication signals transmitted and received through the physical-layer module.

The storage unit 650 includes a mass storage device such as a solid-state drive (SSD) or a hard disk drive (HDD), for example.

For example, application programs and content downloaded through the communication unit 640, image data such as still images and moving images shot with the camera unit 660, and the like are stored in the storage unit 650.

The camera unit 660 is provided with a lens (not illustrated), an image sensor 661 that photoelectrically converts light taken in through the lens, such as a CMOS or CCD sensor, and an analog front end (AFE) 662 that performs noise removal and digi-tization on a detection signal from the image sensor 661 to generate image data, and outputs the generated image data from a camera interface 663 to the control unit 610.

The sensor unit 670 includes a Global Positioning System (GPS) sensor for acquiring position information about the information terminal 103, a gyro sensor and an acceleration sensor for detecting the attitude of and forces acting on the body of the information terminal 103, and the like.

The delivery system 104 makes arrangements for a package ordered by the user to be delivered to a designated delivery address.

The delivery system 104 cooperates with the package receipt support system 100 to provide the package receipt support service to the user. The functions and roles fulfilled by the delivery system 104 will be described later. Also, illustration and a detailed description of the internal configuration of the delivery system 104 is omitted. The delivery system 104 is a server operated by a specific delivery company for example, or in some cases is configured by a cloud system.

Next, the mechanism for supporting the receipt of a package from the delivery person when the user is not at home (or without involving the user) in the package receipt support system 100 according to the present embodiment will be described.

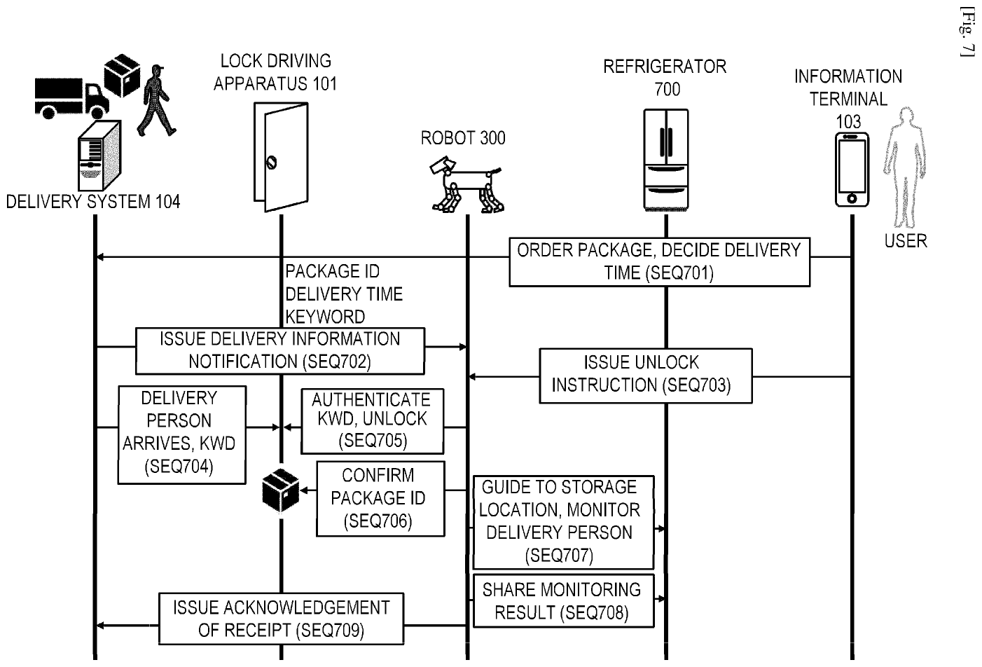

FIG. 7 illustrates an exemplary operation sequence performed by the package receipt support system 100. The diagram illustrates an exemplary operation sequence for a case in which, because the user is not at home when the delivery person delivers the package ordered by the user (or the user is unable to handle receipt of the delivery), the robot 300 (information processing apparatus 102) handles receipt of the delivery instead. It is also assumed that the delivered package is a refrigerated item, and the delivery person is asked not only to enter the user's room, but also to store the package in a refrigerator 700 that acts as a storage location.

First, the user uses an online shopping site or the like to order a package from the information terminal 103 such as a smartphone or tablet carried by the user (SEQ701). When placing the order, the user may also designate a delivery time for the package.

The online shopping site is omitted from illustration in FIG. 7.

The online shopping site consigns delivery of the package ordered by the user to the delivery system 104 operated by a predetermined delivery company. However, the case in which the online shopping site and the delivery company are identical is also anticipated.

The delivery system 104 makes arrangements for a package ordered by the user to be delivered to a designated delivery address.

Herein, the delivery address of the package is described as being the user's own home. Obviously, it should be understood that even if a delivery address other than the user's home is designated, the package receipt support system 100 similarly supports the receipt of the package from the delivery person when the user is not present. Also, the delivery system 104 basically decides the delivery time within a time window designated by the user, but in some cases, depending on the delivery status, the delivery system 104 may also decide a delivery time outside the time designated by the user, or decide any delivery time in cases where the user does not designate a time.

Also, the delivery system 104 issues identification information (hereinafter also called the “package ID”) for uniquely identifying the package to deliver to the user (or for checking the authenticity of the package or the package delivery person).

The identification information may be any information capable of ensuring the certainty of the product ordered by the user, and may include text information containing a plurality of alphanumeric characters, or may be graphic information such as a barcode or a QR code (registered trademark). Alternatively, the package ID may be information stored in a tamper-resistant device such as an IC tag.

In addition, the delivery system 104 issues a keyword with which the delivery person delivering the package ordered by the user calls out to the robot 300. The keyword serves as an “activation word” that activates the robot 300 who acts as an agent on behalf of the user. Also, the keyword serves as a “secret word” or “password” indicating that the delivery person is authentic.

Subsequently, the delivery system 104 notifies the user side of “delivery information” related to the delivery of the ordered package, including the package ID, the decided delivery time, and the keyword (SEQ702). Note that the delivery information may also include information other than the package ID, the delivery time, and the keyword. For example, the delivery information may also include information for proving the authenticity of the delivery person, such as a face photo or voice information (a voiceprint) of the delivery person.

The delivery system 104 transmits the above delivery information to either of the robot 300 standing by in the user's home and the information terminal 103 of the user. In the case in which the delivery information is transmitted to the information terminal 103, the information terminal 103 forwards the received delivery information to the robot 300. In the case in which a plurality of robots is installed in the user's home, the information terminal 103 (or the user) selects the robot 300 to be responsible for acting as the proxy receiving the package when the user is not at home, and forwards the delivery information to the selected robot 300. Also, in the case in which address information of the robot 300 is unknown or which of a plurality of robots installed in the user's home the delivery information should be transmitted to is unknown, the delivery system 104 may be configured to transmit the delivery information to the information terminal 103 from which the order of the package originated.

Next, when the package delivery person comes to the home, the user issues, to the robot 300 through the information terminal 103, an “unlock instruction” for driving the lock driving apparatus 101 to unlock the front door (SEQ703). The unlock instruction may also include information related to the package delivery time. Alternatively, in cases such as where the robot 300 that has received the delivery information will receive the package on behalf of the user without exception, the process in SEQ703 can be omitted.

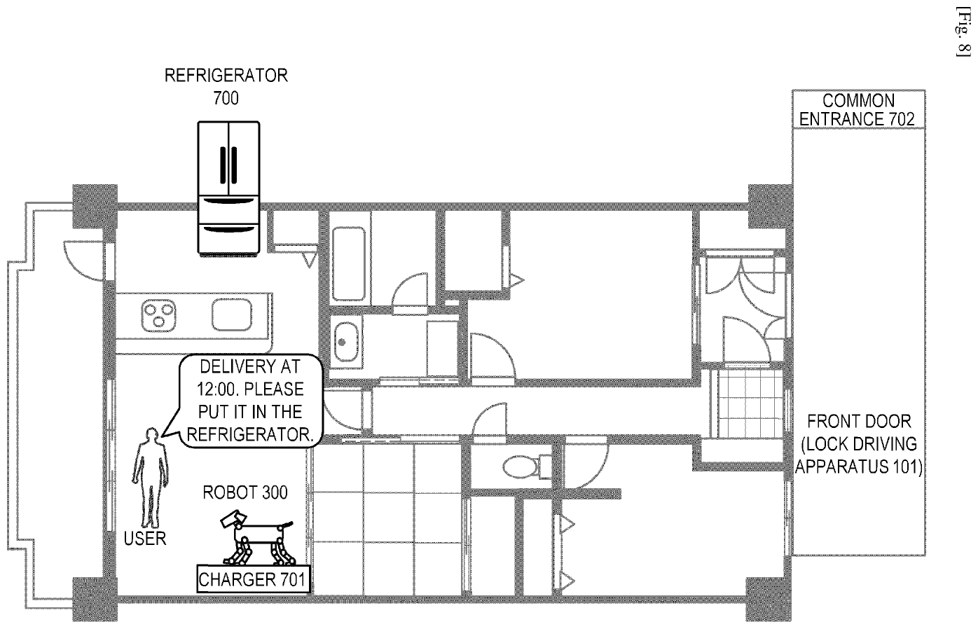

The user may issue the unlock instruction to the robot 300 through wireless communication from the information terminal 103, or by using a voice user interface (UI). FIG. 8 illustrates a situation in which the user uses the voice UI to issue the unlock instruction “Delivery at 12:00. Please put it in the refrigerator.” to the robot 300. At this time, the robot 300 may be connected to a charger 701 and standing by while charging.

After that, the robot 300 stands by until the delivery time designated by the delivery system 104 or the information terminal 103. Note that in the case in which the delivery time is not designated, the robot 300 stands by until the package arrives.

At this point, if the delivery time arrives and the delivery person brings the package according to schedule, the robot 300 performs a delivery person authentication process on the basis of the keyword issued in advance as the delivery information (SEQ704).

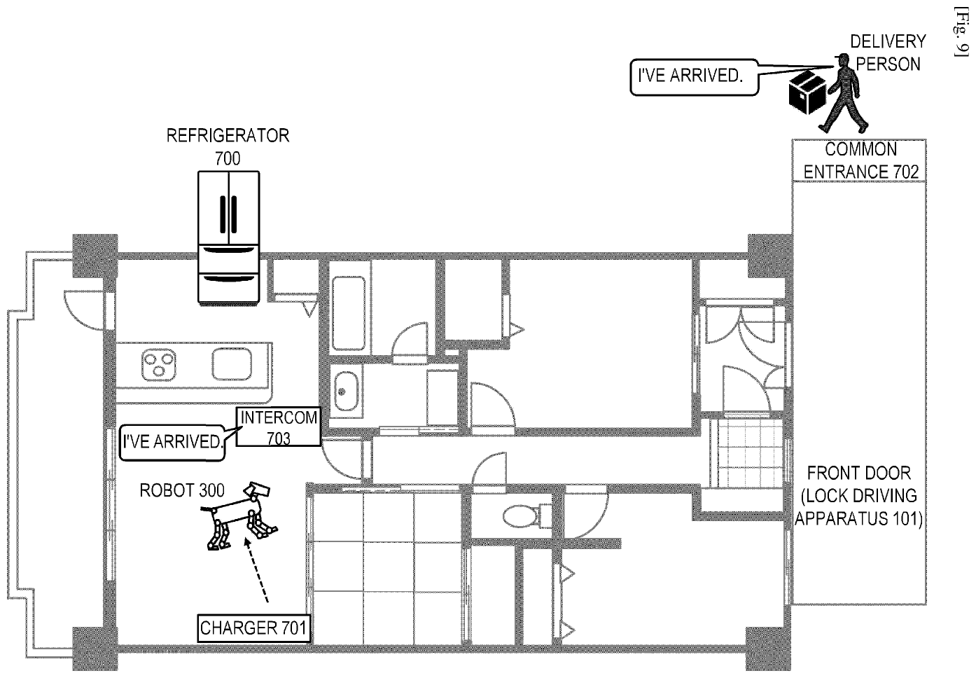

FIGS. 9 to 11 anticipate a case in which the user's residence is in a housing complex, and illustrate how the robot 300 responds to a call from the delivery person. In the case of a housing complex, typically, it is necessary for visitors to call a dwelling at each of a common entrance and a dwelling entrance, and request that someone unlock the door.

FIG. 9 illustrates how the delivery person calls the dwelling of the user to visit from a common entrance intercom (not illustrated) installed in a common entrance 702 of the housing complex. A dwelling intercom 703 rings a call sound and also displays a face image of the delivery person shot with a monitor camera (not illustrated) of the common entrance 702. The robot 300 on standby separates from the charger 701 and approaches the dwelling intercom 703. At this time, the robot 300 may respond to the call sound, or the dwelling intercom 703 may be configured to notify the robot 300 of the dwelling call wirelessly.

The robot 300 wirelessly communicates with the dwelling intercom 703 and enters a talk state with the common entrance intercom. Obviously, the robot 300 may also be configured to use its limbs and the like to press a talk button of the dwelling intercom 703 and enter the talk state with the common entrance intercom.

Through the intercom, the robot 300 can hear an utterance by the delivery person at the common entrance, such as “I've arrived”.

At this time, by having the delivery person say the keyword issued in advance as the delivery information, the robot 300 performs speech recognition on the utterance and performs keyword authentication. Also, in the case in which a face photo of the delivery person is transmitted as the delivery information, the robot 300 may also be configured to perform an authenticity check based on face recognition at the same time, on the basis of the face image of the delivery person displayed on a monitor screen of the dwelling intercom 703. Also, in the case in which the delivery information includes voice information (a voiceprint) of the delivery person, the robot 300 may also be configured to perform an authenticity check of the delivery person at the same time, on the basis of the voice of the delivery person heard from the dwelling intercom 703.

Herein, in the case in which the keyword authentication and the face authentication of the delivery person are unsuccessful, the robot 300 refuses to allow the delivery person to enter the housing complex, and does not unlock the automatic lock of the common entrance. At this time, the robot 300 may notify the information terminal 103 of the user and the delivery system 104 by wireless communication or the like, and furthermore may also report to a security company or the like.

On the other hand, if the keyword authentication as well as the face authentication or voice authentication of the delivery person are successful with respect to the delivery person at the common entrance, the robot 300 unlocks the automatic lock of the common entrance. The robot 300 may instruct the dwelling intercom 703 to unlock the automatic lock of the common entrance through wireless communication, or the robot 300 may use its limbs and the like to press an unlock button on the dwelling intercom 703.

When the door of the common entrance 702 opens, the delivery person proceeds to the dwelling entrance of the user to whom the package is addressed, and this time, the delivery person uses an entrance extension unit (not illustrated) to call the dwelling intercom 703 inside the dwelling.

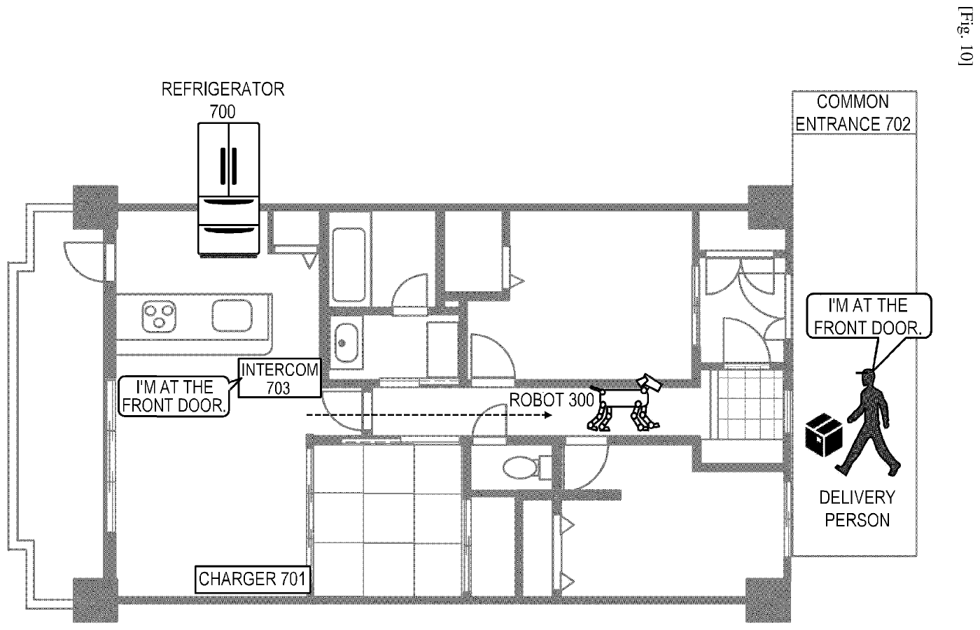

FIG. 10 illustrates how the delivery person uses the entrance extension unit of the user's dwelling to call the intercom inside the dwelling. A dwelling intercom 703 rings a call sound and also displays a face image of the delivery person shot with a monitor camera (not illustrated) of the common entrance 702. The robot 300 may perform the keyword authentication again at the dwelling entrance as well. Alternatively, separate keywords for the common entrance and the dwelling entrance may be set.

Herein, in the case in which the keyword authentication and the face authentication of the delivery person are unsuccessful, the robot 300 refuses to allow the delivery person to enter the dwelling, and does not cause the lock driving apparatus 101 to unlock the dwelling entrance. At this time, the robot 300 reports an abnormality to the information terminal 103 of the user and the delivery system 104 by wireless communication or the like. Additionally, the robot 300 may also report the abnormality to a security company or the like.

On the other hand, if the keyword authentication as well as the face authentication or voice authentication of the delivery person are successful with respect to the delivery person at the dwelling entrance, the robot 300 moves up close to the front door, or in other words the lock driving apparatus 101. Subsequently, the robot 300 communicates with the lock driving apparatus 101 by short-range wireless communication and unlocks the front door (SEQ705).

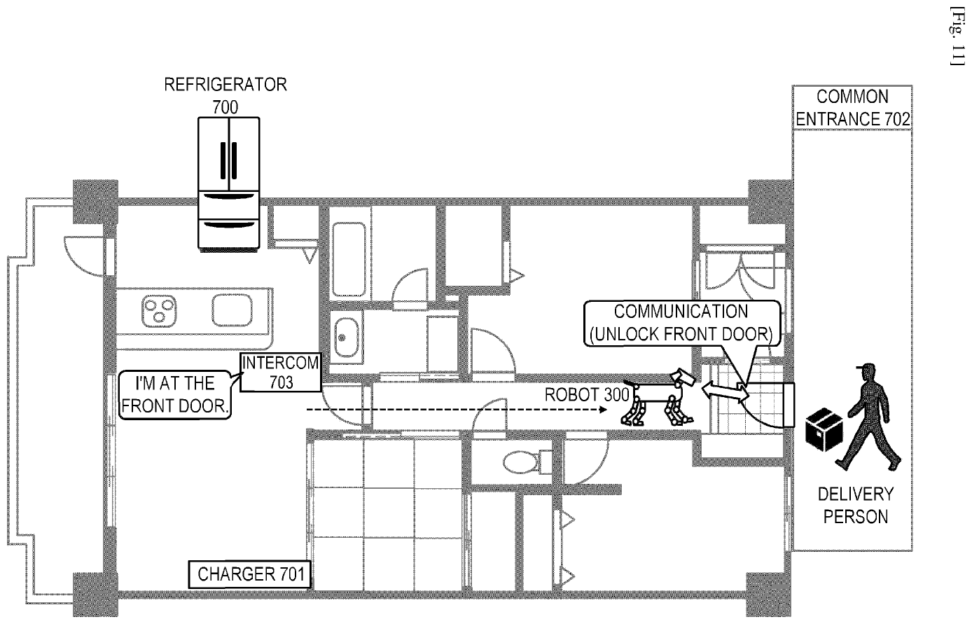

FIG. 11 illustrates how the robot 300 moves to near the entrance, communicates with the lock driving apparatus 101 by short-range wireless communication, and unlocks the front door. As a result of unlocking the front door, the delivery person becomes able to enter the dwelling of the user, and also comes face-to-face with the robot 300. The robot 300 may perform the keyword authentication and the face authentication of the delivery person again. In addition, a face-to-face keyword different from those for the common entrance and the dwelling entrance may also be set.

The robot 300 unlocks the front door and ushers the delivery person into the dwelling, and at the same time starts monitoring the delivery person with the cameras 481L and 481R. Thereafter, the robot 300 guides the delivery person into the dwelling to have the delivery person store the package in the refrigerator 700 that acts as the storage location, and also continues monitoring by camera until the delivery person exits the dwelling. The robot 300 is configured to monitor from a location where an overview of the delivery person's movements can be obtained. The robot 300 may also inform the delivery person that he or she is being monitored by camera.

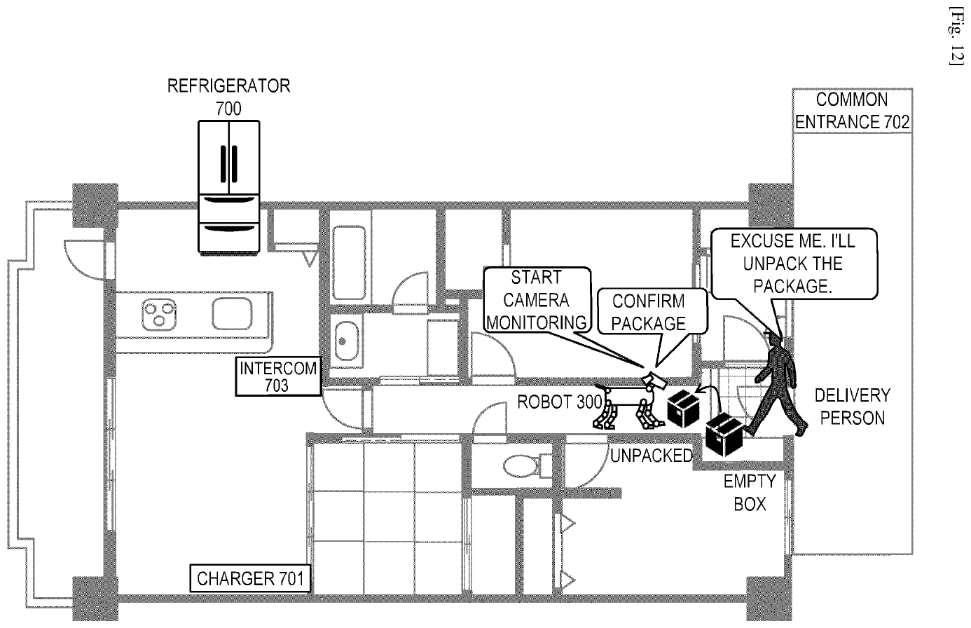

Additionally, when the delivery person enters the dwelling entrance, the robot 300 performs a confirmation of the package ID (SEQ706). FIG. 12 illustrates how the robot 300 confirms the package ID of the package carried in by the delivery person.

When the delivery person enters the dwelling entrance, the robot 300 starts monitoring with the cameras 481L and 481R. Note that in the case in which the dwelling is a smart home, smart lighting may be configured to turn on in response to the delivery person coming in. Also, the robot 300 instructs the delivery person coming into the dwelling entrance to unpack the package by voice guidance output from the speaker 472 or by displaying a text message on the display unit 455, for example.

The delivery person follows the instructions from the robot 300 and unpacks the package, exposing the package ID. The package ID is identification information ensuring the certainty of the product ordered by the user, and includes text information containing a plurality of alphanumeric characters, graphic information such as a barcode or a QR code (registered trademark), an IC tag, or the like (as described earlier). The robot 300 is capable of confirming the package ID by performing an image recognition process on the text information or graphic information, reading the IC tag with a tag reader, or the like.

Herein, in the case in which the confirmation of the package ID is unsuccessful, such as in the case where a product different from the one that the user ordered has arrived, for example, the robot 300 does not lead the delivery person to the storage location, and instead instructs the delivery person to collect the package and leave. At this time, the robot 300 may also notify the information terminal 103 of the user that the desired package has not arrived. The user who has received such a notification may use the information terminal 103 to request re-delivery of the correct package from the online shopping site where the order has been placed or the delivery system 104. Also, in the case in which the robot 300 receives new instructions from the user through the information terminal 103, the robot 300 may act accordingly.

On the other hand, if the confirmation of the package ID is successful, next, the robot 300 leads the delivery person to the refrigerator 700 that acts as the storage location, and instructs the delivery person to store the package inside the refrigerator 700 (SEQ707). While guiding the delivery person inside the dwelling, the robot 300 continues to monitor the delivery person with the cameras 481L and 481R from a location from which an overview can be obtained.

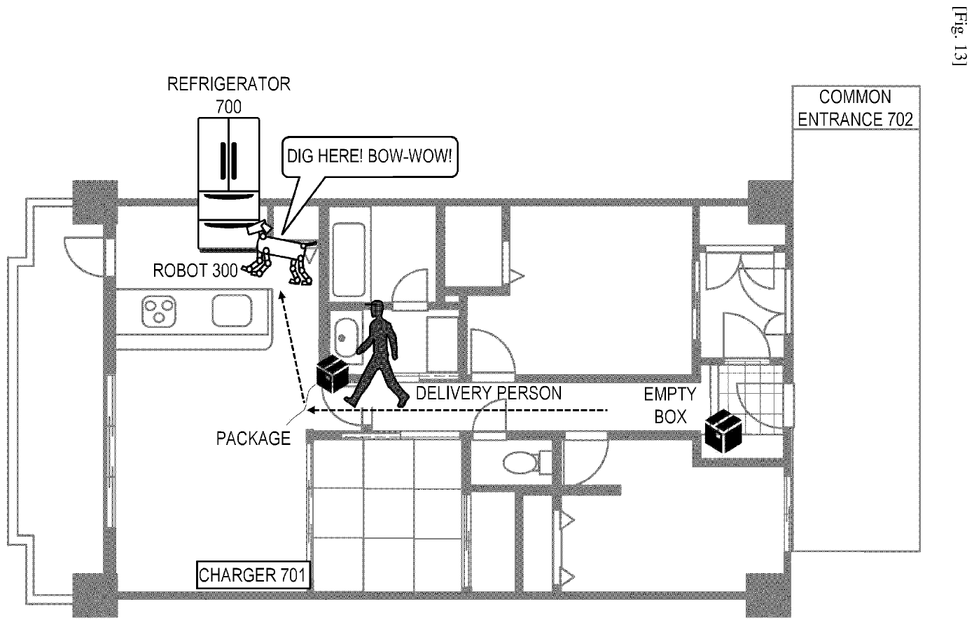

FIG. 13 illustrates how the robot 300 guides the delivery person to the refrigerator 700 that acts as the storage location of the package. The method by which the robot 300 leads the delivery person to the storage location is not particularly limited. In the case in which the robot 300 is dog-like, for example, a stereotypical action such as “Dig here. Bow-wow!” may be used to lead the delivery person. In addition, the robot 300 may also be configured to change the action for leading the delivery person according to temporal changes in the emotion model, the instinct model, or the development model.

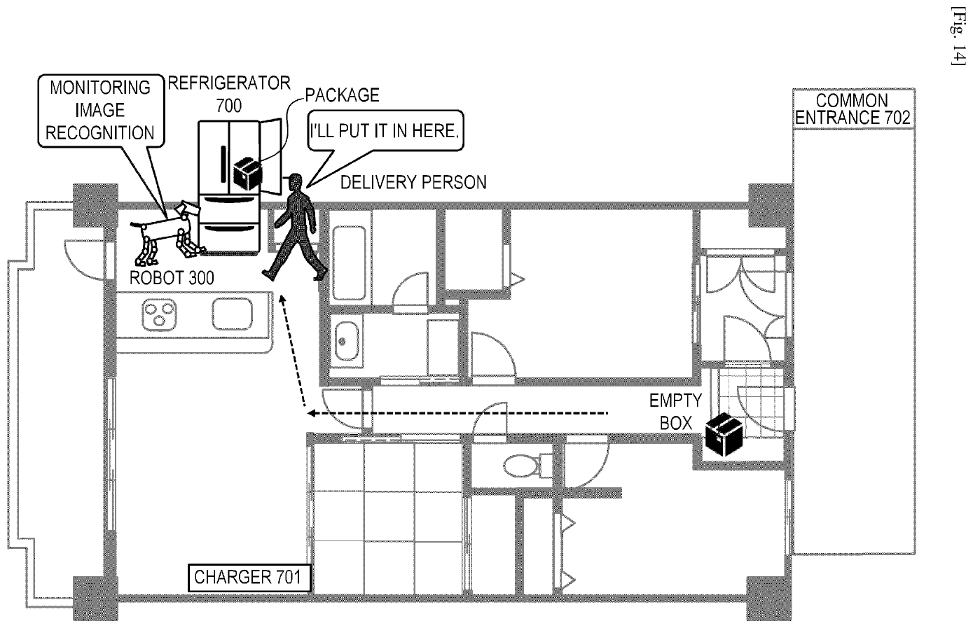

Also, FIG. 14 illustrates how, at the point in time when the delivery person arrives in front of the refrigerator 700, the robot 300 instructs the delivery person to store the package in the refrigerator 700. The package being carried in needs to be kept refrigerated, and if the delivery person is guided in front of the refrigerator 700, in some cases the delivery person is able to infer that he or she should put the package inside the refrigerator 700. The robot 300 monitors the state of the delivery person storing the package in the target location on the basis of image recognition by the cameras 481L and 481R. Where appropriate, the user teaches the robot 300 in advance the method of storing the package, such as how to open and close the refrigerator 700 and the motion of the refrigerator 700.

For example, in the case in which the refrigerator 700 is a smart appliance, the robot 300 shares the result of monitoring the delivery person with the refrigerator 700 (SEQ708). Also, in the case in which the refrigerator 700 is not a smart appliance, the recognition capabilities of the robot 300 may be utilized to make the refrigerator 700 operate as a pseudo-smart appliance.

For example, the refrigerator 700 may be configured to switch the refrigeration mode (for example, switching to quick-freezing) in response to the package being stored, or check whether or not the package has been placed in a correct space (such as in the freezer compartment or the chilled compartment, for example) inside the refrigerator. If the location where the package has been placed is not correct, the refrigerator 700 notifies the robot 300, and the robot 300 may prompt the delivery person to move the package inside the refrigerator. Also, in the case in which the refrigerator 700 is not a smart appliance, the robot 300 may switch the refrigeration mode itself on the basis of a monitoring result or request the delivery person to perform a mode-switching operation by a speech message or the like.

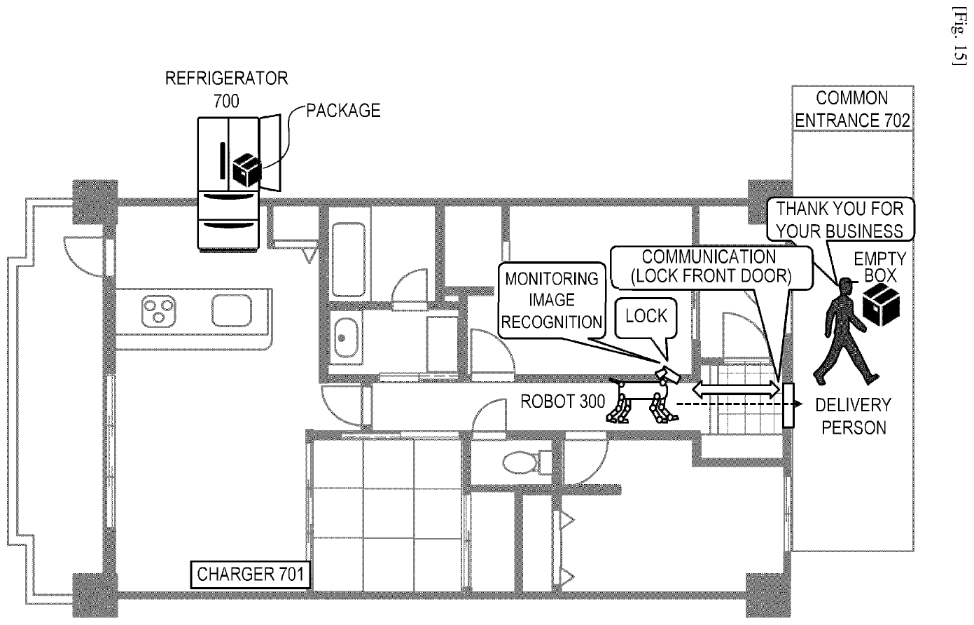

When the storage of the package is completed, the robot 300 leads the delivery person to the doorway and sees the delivery person depart. The monitoring by camera is continued until the delivery person exits to the outside of the dwelling entrance. FIG. 15 illustrates how, after the package is stored in the refrigerator 700, the robot 300 leads the delivery person to the doorway and sees the delivery person depart. Note that in the case in which the dwelling is a smart home, smart lighting may be configured to turn off in response to the delivery person exiting the dwelling.

In the case in which unpacking of the package has left an empty box, the robot 300 may instruct the delivery person to collect the empty box when leaving. For example, the robot 300 can instruct the delivery person to collect the empty box by voice guidance output from the speaker 472 or by displaying a text message on the display unit 455, for example.

Additionally, if the robot 300 confirms by a camera image or the like that the delivery person has exited to the outside of the dwelling entrance, the robot 300 communicates with the lock driving apparatus 101 by short-range wireless communication to lock the front door.

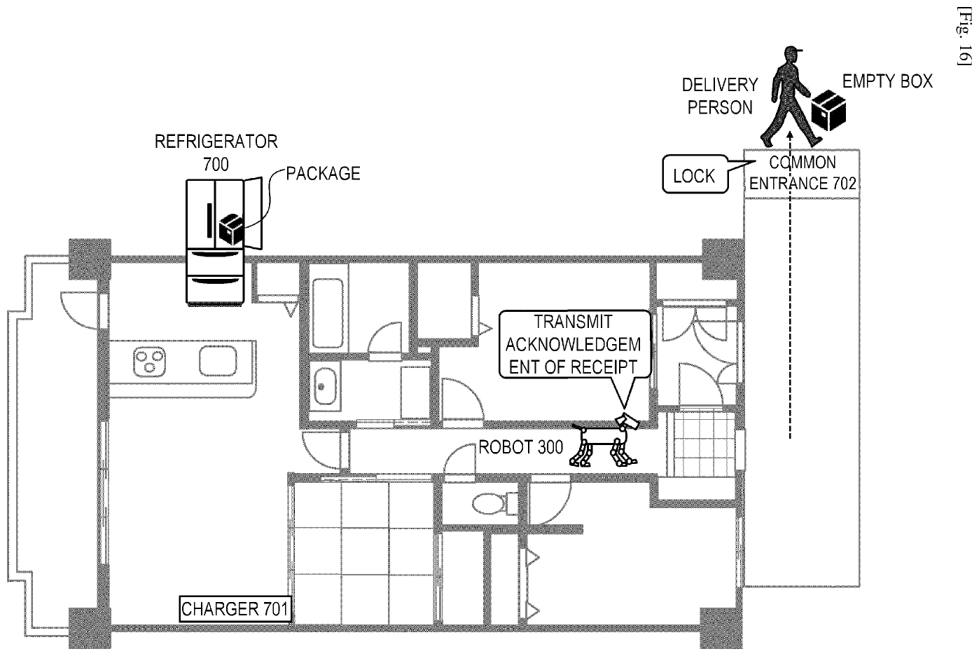

When the robot 300 completes seeing the delivery person depart and locks the dwelling entrance, the robot 300 transmits an acknowledgment of receipt to notify the delivery system 104 that the delivery of the package is complete (SEQ709). The robot 300 may also be configured to additionally notify the information terminal 103 of the user that the receipt of the package is complete. Alternatively, the robot 300 may be configured to issue the acknowledgment of receipt of the package to the delivery system 104 through the information terminal 103 of the user. FIG. 16 illustrates how the robot 300 transmits the acknowledgment of receipt of the package. The timing for transmitting the acknowledgment of receipt does not have to be a time when the delivery person exits the dwelling, and may also be a time when the delivery person exits the common entrance 702 of the housing complex and the door of the common entrance is locked.

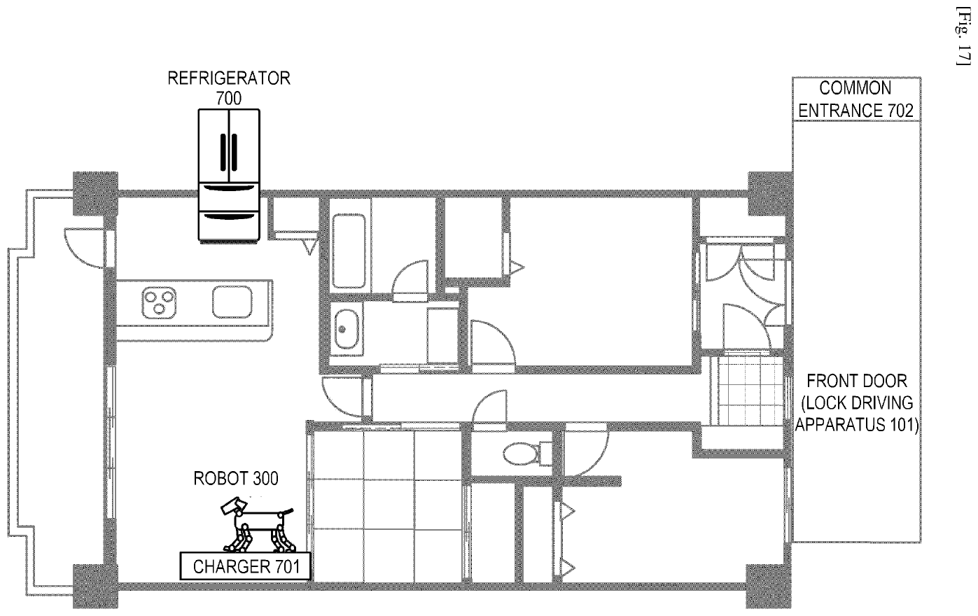

When the robot 300 completes the task of receiving the package that the robot 300 has been notified of in SEQ702 above, the robot 300 goes back to the charger 701 and stands by until the user comes home or the next task starts, such as the delivery of another package. FIG. 17 illustrates how the robot 300 returns to the charger 701 and stands by.

The robot 300 continually monitors the delivery person with the cameras 481L and 481R during the period from when the delivery person is invited into the dwelling until the delivery person exits the dwelling entrance. In addition, the robot 300 may also stream the result of monitoring the delivery person to the information terminal 103 of the user who has gone out.

If the robot 300 detects that the delivery person is engaging in unexpected behavior inside the dwelling, the robot 300 may be configured to issue a warning to correct the delivery person's behavior. Examples of the “unexpected behavior” referred to herein include the following (1) to (7), for example.

(1) The delivery person departs significantly from the guided route indicated by the robot 300.

(2) The delivery person moves to a location other than the location shown by the robot 300.

(3) The delivery person places the package in a location other than the storage location indicated by the robot 300.

(4) The delivery person attempts to make off with the package.

(5) The delivery person places an item other than the package inside the dwelling.

(6) The delivery person arbitrarily touches, steals, or destroys items inside the dwelling.

(7) The delivery person engages in a behavior other than delivery behavior.

The warning issued by the robot 300 may be voice guidance output from the speaker 472 or a text message displayed on the display unit 455, for example. Also, in the case in which the robot 300 is dog-like, the robot 300 may bark “BOW. BOW!” and in-timidate the delivery person.

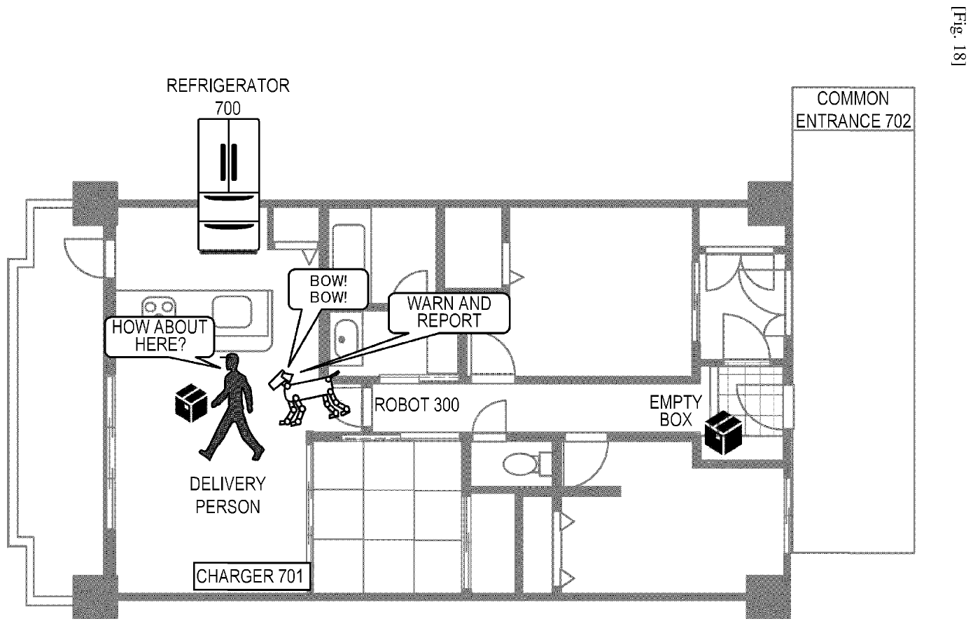

When the delivery person does not correct one's own behavior, such as by returning to the anticipated route or location, or by letting go of an item inside the dwelling, even though the robot 300 has issued a warning, the warning level may be increased gradually, such as by sounding a loud alarm, for example. If circumstances permit, the robot 300 may also apply an electrical or other type of shock or restrain the unauthorized delivery person. Additionally, the robot 300 may also be configured to communicate with the lock driving apparatus 101 by short-range wireless communication to lock the front door and deter the unauthorized delivery person from leaving. Also, the robot 300 may be configured to report the suspicious behavior by the delivery person inside the dwelling to the delivery system 104 and the information terminal 103 of the user. FIG. 18 illustrates how the robot 300 warns and reports a suspicious delivery person.

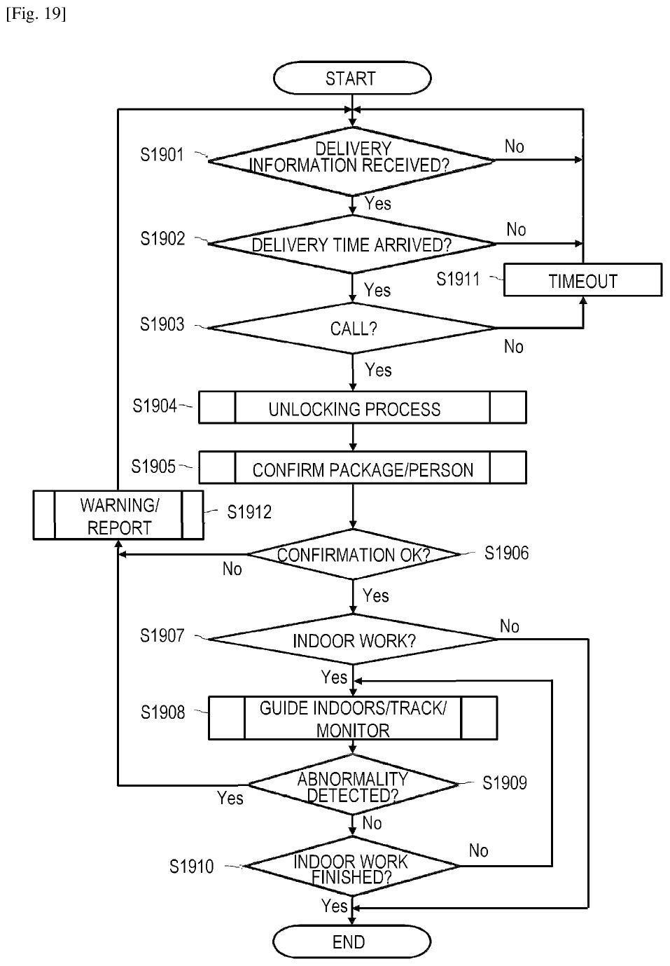

FIG. 19 illustrates, in flowchart form, a processing procedure executed for the information processing apparatus 102 configured as the robot 300 to receive a package instead of the user in the package receipt support system 100 according to the present embodiment.

Until delivery information related to the delivery of a package ordered by the user is received from the delivery system 104 (No in step S1901), the robot 300 stands by while charging the battery 474 at the charger 701, for example. At this time, the robot 300 may stand by while saving power by putting at least some of its functions in a dormant state. However, in some cases, the delivery information is received through the information terminal 103 of the user rather than the delivery system 104.

When the robot 300 receives delivery information from the delivery system 104 (Yes in step S1901), until the delivery time designated by the delivery information arrives (No in step S1902), the robot 300 remains standing by while charging the battery 474 at the charger 701, for example. The robot 300 may stand by while saving power by putting at least some of its functions in a dormant state (as above).

In the case in which the robot 300 stands by while putting at least some of its functions in a dormant state, when the designed delivery time approaches, the robot 300 reactivates the dormant functions and returns to a state capable of immediately re-sponding to a visit by the delivery person.

At this point, if the designated delivery time arrives (Yes in step S1902) but there is no call from the delivery person (No in step S1903), and a predetermined amount of time elapses, a timeout occurs (step S1911), the flow returns to step S1901, and the robot 300 reenters the standby state.

Also, after the designated delivery time arrives (Yes in step S1902), if there is a call by the delivery person on the dwelling intercom 703 inside the dwelling from the common entrance of the housing complex or the dwelling entrance within a predetermined amount of time (Yes in step S1903), the robot 300 performs the process of unlocking the common entrance of the housing complex and the dwelling entrance (step S1904), and invites the delivery person into the dwelling.

In step S1904, while performing the process of unlocking the common entrance of the housing complex or the dwelling entrance, the robot 300 acquires the keyword spoken by the delivery person.

Also, the robot 300 acquires a face image of the delivery person shot by the monitor camera of the common entrance intercom or the entrance extension unit of the dwelling, and also acquires speech spoken by the delivery person. In addition, the robot 300 instructs the delivery person at the doorway to unpack the package. Subsequently, the robot 300 can acquire the package ID from the package that the delivery person has unpacked and taken out. Subsequently, on the basis of keyword authentication as well as face authentication and voice authentication of the delivery person, the robot 300 confirms the identity of the delivery person and also confirms the package on the basis of the package ID (step S1905).

At this point, in the case in which either one of the identity confirmation and the package confirmation is unsuccessful (No in step S1906), the robot 300 refuses to allow the delivery person to enter the housing complex or the dwelling, instructs the delivery person to leave if the delivery person has already come through the entrance of the dwelling, and reports an abnormality to the information terminal 103 of the user and the delivery system 104 through wireless communication or the like (step S1912). Additionally, the robot 300 may also report the abnormality to a security company or the like. After that, the flow returns to step S1901, and the robot 300 reenters the standby state.

Also, in the case in which the identity confirmation and the package confirmation are both successful (Yes in step S1906), the robot 300 checks whether or not there is indoor work to request of the delivery person, such as carrying the package indoors and storing the package in a predetermined storage location (such as the refrigerator 700, for example) (step S1907).

In the case in which there is no indoor work to request of the delivery person (No in step S1907), the robot 300 thanks the delivery person for the delivery, prompts the delivery person to leave the dwelling, and ends the process. However, in the case in which unpacking of the package has left an empty box, the robot 300 instructs the delivery person to collect the empty box.

Also, in the case in which there is indoor work to request of the delivery person (Yes in step S1907), the robot 300 leads the delivery person indoors and instructs the delivery person to perform indoor work such as storing the package in a predetermined storage location (such as the refrigerator 700, for example). During this time, the robot 300 tracks the delivery person and continues monitoring on the basis of camera images or the like (step S1908).

At this point, in the case in which an abnormality is detected such as a case where the delivery person departs significantly from a delivery behavior (Yes in step S1909), the robot 300 issues a warning, and further, refuses to allow the delivery person to enter the housing complex or the dwelling, instructs the delivery person to leave if the delivery person has already come through the entrance of the dwelling, and reports an abnormality to the information terminal 103 of the user and the delivery system 104 through wireless communication or the like (step S1912). Additionally, the robot 300 may also report the abnormality to a security company or the like. After that, the flow returns to step S1901, and the robot 300 reenters the standby state.

On the other hand, in the case in which no movement in a behavior of the delivery person is detected (No in step S1909), the indoor work has been completed safely (Yes in step S1910), the robot 300 thanks the delivery person for the delivery, prompts the delivery person to leave the dwelling, and ends the process. However, in the case in which unpacking of the package has left an empty box, the robot 300 instructs the delivery person to collect the empty box.

### INDUSTRIAL APPLICABILITY

The foregoing thus describes the technology disclosed in this specification in detail and with reference to specific embodiments. However, it is obvious that persons skilled in the art may make modifications and substitutions to these embodiments without departing from the spirit of the technology disclosed in this specification.

This specification mainly describes an embodiment in which the technology disclosed in the specification is configured by primarily using a pet-type robot, but the gist of the technology disclosed in the specification is not limited thereto. For example, the package receipt support service can be achieved similarly by using a humanoid robot, an unmanned aerial vehicle such as a drone, a robot vacuum cleaner, or the like.

Essentially, the technology disclosed in this specification has been described by way of example, and the stated content of this specification should not be interpreted as being limiting. The spirit of the technology disclosed in this specification should be determined in consideration of the claims.

Additionally, the technology disclosed in the present specification can also be configured as below.

(1) An information processing apparatus installed inside a room acting as a delivery address of a package, including:

a communication unit configured to communicate with a lock driving apparatus that locks and unlocks a front door; and

a control unit configured to control the locking and unlocking of the front door through the communication unit according to a status.

(2) The information processing apparatus according to (1), in which

the control unit controls the locking and unlocking of the front door on the basis of a status of the package or a status of a delivery person who delivers the package.

(3) The information processing apparatus according to (1) or (2), in which

the control unit controls the locking and unlocking of the front door according to an unlock request from the delivery person.

(4) The information processing apparatus according to any one of (1) to (3), in which

the delivery address of the package is a dwelling inside a housing complex, and
the control unit controls the locking and unlocking of a door of at least one of a common entrance of the housing complex or an entrance of the dwelling.

(5) The information processing apparatus according to any one of (1) to (4), in which

the control unit controls the locking and unlocking of the front door in accordance with a delivery time of the package designated in advance.

(6) The information processing apparatus according to any one of (1) to (5), in which

the control unit authenticates the delivery person on the basis of a keyword issued in advance, and controls the locking and unlocking of the front door according to a result of the authentication.

(7) The information processing apparatus according to any one of (1) to (6), in which

the control unit authenticates the delivery person on the basis of a face image issued in advance, and controls the locking and unlocking of the front door according to a result of the authentication.

(8) The information processing apparatus according to any one of (1) to (7), in which

the control unit authenticates the delivery person on the basis of voice information issued in advance, and controls the locking and unlocking of the front door according to a result of the authentication.

(9) The information processing apparatus according to any one of (1) to (8), in which

after unlocking the front door, the control unit additionally controls a process of authenticating the package delivered by the delivery person on the basis of a package ID issued in advance.

(10) The information processing apparatus according to any one of (1) to (9), in which

the control unit additionally controls an external notification of an authentication result regarding at least one of the delivery person or the package.

(11) The information processing apparatus according to any one of (1) to (10), in which

the control unit additionally controls a conversation with the delivery person.

(12) The information processing apparatus according to (11), in which

after unlocking the front door, the control unit controls the conversation to instruct the delivery person to unpack the package.

(13) The information processing apparatus according to (12), in which

when the delivery person leaves, the control unit controls the conversation to instruct the delivery person to collect an empty box produced by the unpacking of the package.

(14) The information processing apparatus according to any one of (1) to (13), further including:

a movement unit that causes a body of the information processing apparatus to move, in which
when locking and unlocking the front door, the control unit controls movement such that the lock driving apparatus is within a communication range of the communication unit.

(15) The information processing apparatus according to (14), in which

after unlocking the front door, the control unit controls movement to guide the delivery person inside the room.

(16) The information processing apparatus according to (14) or (15), in which

the control unit controls movement to lead the delivery person to a storage location of the package.

(17) The information processing apparatus according to any one of (14) to (16), in which

the control unit performs control to monitor a behavior of the delivery person inside the room.

(18) An information processing method including:

detecting a status of a package or a status of a delivery person delivering the package;
making a decision regarding locking and unlocking a front door of a room acting as a delivery address of the package according to the status; and
communicating with a lock driving apparatus that locks and unlocks the front door on the basis of a result of the decision.

(19) A computer program stated in a computer-readable format causing a computer to function as:

a communication unit configured to communicate with a lock driving apparatus that locks and unlocks a front door; and
a control unit configured to control the locking and unlocking of the front door through the communication unit according to a status.

(20) A package receipt support system including:

a lock driving apparatus configured to lock and unlock a front door; and
an information processing apparatus installed inside a room acting as a delivery address of a package, the information processing apparatus including a communication unit configured to communicate with the lock driving apparatus and a control unit configured to control the locking and unlocking of the front door through the communication unit according to a status.

(21) An information processing apparatus, comprising:

a body and a movement device attached thereto, wherein the body comprises a control unit in communication with the movement device, the control unit comprising a processor and a memory configured to store instructions that, when executed by the processor, cause the processor to:
detect data indicative of a delivery person within a building; and
guide the delivery person to a package delivery location, wherein guiding the delivery person comprises:
controlling the movement device to move the information processing apparatus in a direction that guides the delivery person to the package delivery location; and
monitoring the delivery person.

(22) The information processing apparatus of (21), wherein the information processing apparatus comprises a mobility device.

(23) The information processing apparatus of (21), wherein the movement device comprises a set of legs, each leg comprising a set of rigid components and a set of joints.

(24) The information processing apparatus of (21), further comprising a camera in communication with the control unit, wherein the instructions are further configured to cause the processor to:

receive second data from the camera;
detect, based on the received second data from the camera, the data indicative of the delivery person; and
wherein monitoring the delivery person comprises monitoring the delivery person, based on the received second data from the camera.

(25) The information processing apparatus of (21), wherein the instructions are further configured to cause the processor to:

receive authentication data comprising an access keyword, data associated with the delivery person, or some combination thereof;
authenticate the delivery person based on the authentication data; and communicate with a lock driving apparatus to unlock a door of the building.

(26) The information processing apparatus of (21), wherein the instructions are further configured to cause the processor to:

store second data associated with an expected package;
receive third data indicative of identifying information of a package; and compare the stored second data with the received third data.

(27) The information processing apparatus of (21), wherein guiding the delivery person to the package delivery location comprises:

estimating a position of the information processing apparatus;
determining a route to the package delivery location; and
using the determined route and estimated position to guide the delivery person to the package delivery location.

(28) The information processing apparatus of (21), further comprising a speaker, a display, or both, wherein the instructions are further configured to cause the processor to use the speaker, the display, or both, to guide the delivery person to the package delivery location.

(29) The information processing apparatus of (21), wherein monitoring the delivery person comprises one or more of monitoring the delivery person:

during entry into the building;
while guiding the delivery person to the package delivery location;
while the delivery person places a package at the package delivery location;
while guiding the delivery person to from package delivery location to the entrance of the building; and
while exiting the entrance of the building.

(30) The information processing apparatus of (21), wherein the instructions are further configured to cause the processor to:

determine the delivery person is engaging in an unexpected behavior inside the building; and
issuing a warning to correct the unexpected behavior of the delivery person.

(31) A method comprising using a control unit of an information processing apparatus comprising a processor and a memory configured to store instructions that, when executed by the processor, cause the processor to perform the acts of:

detecting data indicative of a delivery person within a building; and guiding the delivery person to a package delivery location, wherein guiding the delivery person comprises:
controlling a movement device attached to a body comprising the processor to move the information processing apparatus in a direction that guides the delivery person to the package delivery location; and
monitoring the delivery person.

(32) The method of (31), wherein the information processing apparatus comprises a mobility device.

(33) The method of (31), wherein controlling the movement device comprises controlling a set of legs, each leg comprising a set of rigid components and a set of joints.

(34) The method of (31), further comprising:

receiving second data from a camera in communication with the control unit;
detecting, based on the received second data from the camera, the data indicative of the delivery person; and
wherein monitoring the delivery person comprises monitoring the delivery person, based on the received second data from the camera.

(35) The method of (31), further comprising:

receiving authentication data comprising an access keyword, data associated with the delivery person, or some combination thereof;
authenticating the delivery person based on the authentication data; and communicating with a lock driving apparatus to unlock a door of the building.

(36) The method of (31), further comprising:

storing second data associated with an expected package;
receiving third data indicative of identifying information of a package; and
comparing the stored second data with the received third data.

(37) The method of (31), wherein guiding the delivery person to the package delivery location comprises:

estimating a position of the information processing apparatus;
determining a route to the package delivery location; and
using the determined route and estimated position to guide the delivery person to the package delivery location.

(38) The method of (31), further comprising using a speaker, a display, or both, to guide the delivery person to the package delivery location.

(39) The method of (31), wherein monitoring the delivery person comprises one or more of monitoring the delivery person:

during entry into the building;
while guiding the delivery person to the package delivery location;
while the delivery person places a package at the package delivery location;
while guiding the delivery person to from package delivery location to the entrance of the building; and
while exiting the entrance of the building.

(40) A package receipt support system comprising:

a lock driving apparatus; and
an information processing apparatus comprising:
a body and a movement device attached thereto, wherein the body comprises a control unit in communication with the movement device, the control unit comprising a processor and a memory configured to store instructions that, when executed by the processor, cause the processor to:
communicate with the lock driving apparatus to unlock an entrance to a building; detect data indicative of a delivery person within the building; and
guide the delivery person to a package delivery location, wherein guiding the delivery person comprises:
controlling the movement device to move the information processing apparatus in a direction that guides the delivery person to the package delivery location; and

monitoring the delivery person.

### REFERENCE SIGNS LIST

100 Package receipt support system
101 Lock driving apparatus
102 Information processing apparatus
103 Information terminal
104 Delivery system
201 Control unit
202 Storage unit
203 Communication unit
204 Door lock mechanism
300 Robot
301 Torso unit
302 Head unit
303 Tail
304 Leg unit
307 Tail joint
308 Femoral unit
309 Tibial unit
310 Hip joint
311 Knee joint
312 Foot unit
451 Touch sensor
452 Control unit
455 Display unit
463 Sub-control unit
471 External sensor unit
472 Speaker
473 Internal sensor unit
474 Battery
475 External memory
476 Communication unit
481 Camera
482 Microphone
491 Battery sensor
492 Acceleration sensor
501 State recognition information processing unit
502 Model storage unit
503 Action decision mechanism unit
504 Attitude transition mechanism unit
505 Speech synthesis unit
610 Control unit
611 CPU
612 ROM
613 RAM
620 Display unit
621 Display panel
622 Display interface
623 Touch panel
624 Touch interface
630 Speech processing unit
631 Speech output unit
632 Speech input unit
633 Speech codec
634 Output terminal
640 Communication unit
650 Storage unit
660 Camera unit
661 Image sensor
662 Analog front end
663 Camera interface
670 Sensor unit

1. An information processing apparatus, comprising:
a body and a movement device attached thereto, wherein the body comprises a control unit in communication with the movement device, the control unit comprising a processor and a memory configured to store instructions that, when executed by the processor, cause the processor to:
detect data indicative of a delivery person within a building; and
guide the delivery person to a package delivery location, wherein guiding the delivery person comprises:
controlling the movement device to move the information processing apparatus in a direction that guides the delivery person to the package delivery location; and
monitoring the delivery person.

2. The information processing apparatus of claim 1, wherein the information processing apparatus comprises a mobility device.

3. The information processing apparatus of claim 1, wherein the movement device comprises a set of legs, each leg comprising a set of rigid components and a set of joints.

4. The information processing apparatus of claim 1, further comprising a camera in communication with the control unit, wherein the instructions are further configured to cause the processor to:
receive second data from the camera;
detect, based on the received second data from the camera, the data indicative of the delivery person; and
wherein monitoring the delivery person comprises monitoring the delivery person, based on the received second data from the camera.

5. The information processing apparatus of claim 1, wherein the instructions are further configured to cause the processor to:
receive authentication data comprising an access keyword, data associated with the delivery person, or some combination thereof;
authenticate the delivery person based on the authentication data; and
communicate with a lock driving apparatus to unlock a door of the building.

6. The information processing apparatus of claim 1, wherein the instructions are further configured to cause the processor to:
store second data associated with an expected package;
receive third data indicative of identifying information of a package; and
compare the stored second data with the received third data.

7. The information processing apparatus of claim 1, wherein guiding the delivery person to the package delivery location comprises:
estimating a position of the information processing apparatus;
determining a route to the package delivery location; and
using the determined route and estimated position to guide the delivery person to the package delivery location.

8. The information processing apparatus of claim 1, further comprising a speaker, a display, or both, wherein the instructions are further configured to cause the processor to use the speaker, the display, or both, to guide the delivery person to the package delivery location.

9. The information processing apparatus of claim 1, wherein monitoring the delivery person comprises one or more of monitoring the delivery person:
during entry into the building;
while guiding the delivery person to the package delivery location;
while the delivery person places a package at the package delivery location;
while guiding the delivery person to from package delivery location to the entrance of the building; and
while exiting the entrance of the building.

10. The information processing apparatus of claim 1, wherein the instructions are further configured to cause the processor to:
determine the delivery person is engaging in an unexpected behavior inside the building; and
issuing a warning to correct the unexpected behavior of the delivery person.

11. A method comprising using a control unit of an information processing apparatus comprising a processor and a memory configured to store instructions that, when executed by the processor, cause the processor to perform the acts of:
detecting data indicative of a delivery person within a building; and
guiding the delivery person to a package delivery location, wherein guiding the delivery person comprises:
controlling a movement device attached to a body comprising the processor to move the information processing apparatus in a direction that guides the delivery person to the package delivery location; and
monitoring the delivery person.

12. The method of claim 11, wherein the information processing apparatus comprises a mobility device.

13. The method of claim 11, wherein controlling the movement device comprises controlling a set of legs, each leg comprising a set of rigid components and a set of joints.

14. The method of claim 11, further comprising:
receiving second data from a camera in communication with the control unit;
detecting, based on the received second data from the camera, the data indicative of the delivery person; and
wherein monitoring the delivery person comprises monitoring the delivery person, based on the received second data from the camera.

15. The method of claim 11, further comprising:
receiving authentication data comprising an access keyword, data associated with the delivery person, or some combination thereof;
authenticating the delivery person based on the authentication data; and
communicating with a lock driving apparatus to unlock a door of the building.

16. The method of claim 11, further comprising:
storing second data associated with an expected package;
receiving third data indicative of identifying information of a package; and
comparing the stored second data with the received third data.

17. The method of claim 11, wherein guiding the delivery person to the package delivery location comprises:
estimating a position of the information processing apparatus;
determining a route to the package delivery location; and
using the determined route and estimated position to guide the delivery person to the package delivery location.

18. The method of claim 11, further comprising using a speaker, a display, or both, to guide the delivery person to the package delivery location.

19. The method of claim 11, wherein monitoring the delivery person comprises one or more of monitoring the delivery person:
during entry into the building;
while guiding the delivery person to the package delivery location;
while the delivery person places a package at the package delivery location;
while guiding the delivery person to from package delivery location to the entrance of the building; and
while exiting the entrance of the building.

20. A package receipt support system comprising:
a lock driving apparatus; and
an information processing apparatus comprising:
a body and a movement device attached thereto, wherein the body comprises a control unit in communication with the movement device, the control unit comprising a processor and a memory configured to store instructions that, when executed by the processor, cause the processor to:
communicate with the lock driving apparatus to unlock an entrance to a building;
detect data indicative of a delivery person within the building; and
guide the delivery person to a package delivery location, wherein guiding the delivery person comprises:
controlling the movement device to move the information processing apparatus in a direction that guides the delivery person to the package delivery location; and
monitoring the delivery person.
